(19) United States
(12) Patent Application Publication
(10) Pub. No.: US 2004/0114458 A1
(43) Pub. Date: Jun. 17, 2004

(54) Device for mixing fluids

(75) Inventors: Jean Berthier, Meylan (FR); Dominique Masse, Coublevie (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: COMMISSARIAT A L'ENERGIE ATOMIQUE, PARIS (FR)

(21) Appl. No.: 10/667,303

(22) Filed: Sep. 23, 2003

(30) Foreign Application Priority Data
Oct. 8, 2002 (FR) 02 12468

(51) Int. Cl. B01F 13/08

(52) U.S. Cl. 366/273

(57) ABSTRACT

The invention concerns a device for mixing fluids.

Said device comprises a chamber (C) in which are present the fluids to be mixed (L1, L2) and means (ai, Ei) for displacing, around a central point, under the action of a force, the particles present in said chamber (C), the trajectory of said particles having radial fluctuations in relation to the central point.

The invention applies to mixtures of fluids and colloids in the fields of chemistry or biology.

### TECHNICAL FIELD AND STATE OF THE PRIOR ART

The invention concerns a device for mixing fluids.

The invention finds a particularly advantageous application in the production of micro-devices for mixing fluids and colloids in the fields of biology or chemistry.

In most existing micro-systems for mixing fluids, the flow of said fluids is slow and very laminar. Streams of fluids run alongside each other over a long distance without mixing together. There is only very limited mixing through diffusion (cf. “Optical measurement of transverse molecular diffusion in a microchannel”, A. Evan-Kamholz, E. A. Shilling, P. Yager; Biophysical Journal, vol. 80, n° 4, Apr. 2001, p. 1967-72).

In the field of chemistry, the low rate of mixing leads to incomplete and non-rapid reactions. In the field of biochemistry, the low diffusion efficiency often prevents a biological constituent from migrating within a carrier fluid.

The invention does not have said disadvantages.

### DESCRIPTION OF THE INVENTION

Indeed, the invention concerns a device for mixing fluids comprising a chamber in which are present the fluids to be mixed. The devices comprises means for displacing, around a central point, under the action of a force, the particles present in said chamber, the trajectory of said particles having radial fluctuations in relation to the central point.

According to a first embodiment of the invention, the particles are paramagnetic beads and the means for displacing the particles comprise means for establishing a magnetic field rotating around the central point.

According to a first variant of said first embodiment of the invention, the means for establishing a magnetic field rotating around the central point comprise permanent magnets rotating around the central point and a ferromagnetic core placed at the level of the central point.

According to a second variant of said first embodiment of the invention, the means for establishing a magnetic field rotating around the central point comprise electromagnets and a ferromagnetic core placed at the level of the central point.

According to a second embodiment of the invention, the particles are molecules of at least one of the fluids to be mixed and the means for displacing the particles comprise means for establishing a dielectrophoretic field rotating around the central point.

According to a further characteristic of said second embodiment of the invention, the means for establishing a dielectrophoretic field rotating around the central point comprise a dielectric core placed at the level of the central point, the dielectric constant of the dielectric core having a value greater than the dielectric constant of the fluids to be mixed, and electrode pairs placed on the periphery of the cavity, two electrodes of a pair being situated opposite each other, on either side of the cavity, said electrode pairs being supplied alternately, in rotating around the dielectric core, by an alternating current.

An advantage of the invention is the possibility of producing a very compact mixing micro-system. As a result of the rotation around a central core, one can make the beads/molecules follow relatively long paths in a reduced space. A linear solution would be much less efficient.

Another advantage of the invention is the efficiency of the mixture obtained thereof. Indeed, the radial excursions of the particles around the central core lead to very efficient diffusion. It is then advantageous to dimension the space in which the mixing is carried out and to select the frequency of the rotating fields in such a way as to maximise said excursions. The radial movement of particles leads to a significant increase in the diffusion coefficient of one species in another.

A third advantage is that it is not necessary for the species to have different dielectric characteristics. Since said species are stirred by the beads moving around the central core (1^{st} embodiment) or themselves made to move around the central core (2^{nd} embodiment), they are mixed together.

A fourth advantage is that one can mix more than two species. Said advantage is particularly important in the field of chemistry, where it often happens that reactions require several constituents.

### BRIEF DESCRIPTION OF THE DRAWINGS

Other characteristics and advantages of the invention will become clear on reading the description of the preferred embodiments and in referring to the drawings, among which:

FIG. 1 represents a schematic diagram of a mixing device according to a first embodiment of the invention;

FIG. 2 represents an example of a mixing device according to said first embodiment of the invention;

FIG. 3 represents a schematic diagram of a mixing device according to a second embodiment of the invention;

FIGS. 4A and 4B represent a plan view and a side view of an example of a mixing device according to said second embodiment of the invention.

### DETAILED DESCRIPTION OF EMBODIMENTS OF THE INVENTION

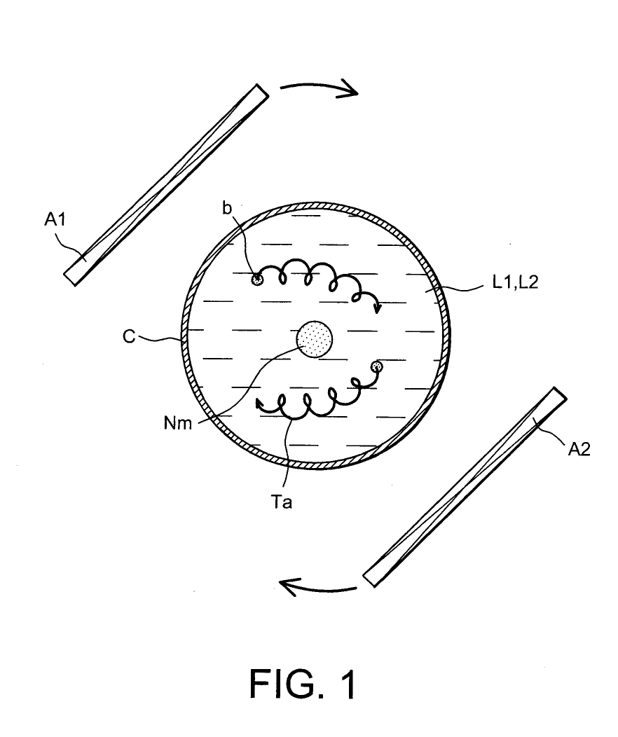

FIG. 1 represents a schematic diagram of a mixing device according to a first embodiment of the invention.

Said device comprises a chamber C which contains the liquids L1, L2 to be mixed, a ferromagnetic core Nm preferentially centred in the chamber C, magnetic means A1, A2 suited to creating a magnetic field rotating around said ferromagnetic core and paramagnetic beads b dispersed in said chamber C (for example, Dynal, Inimunicon or Miltenyi type beads). The magnetic means A1, A2 may be permanent magnets activated by a rotational movement or electromagnets, supplied alternately.

Under the action of the rotating magnetic field, the paramagnetic beads b are displaced around the ferromagnetic core according to a trajectory Ta which has radial fluctuations in relation to the ferromagnetic core. The radial fluctuation movements of the paramagnetic beads stir the particles of liquid and contribute to considerably increasing the diffusion coefficient of one liquid in another.

The radial fluctuations of the paramagnetic beads vary, among others, as a function of the magnetic susceptibility of the beads b and the rotational frequency of the magnetic field. The magnetic susceptibility of the paramagnetic beads and the rotational frequency of the magnetic field thereby constitute adjustment parameters for the mixing of liquids.

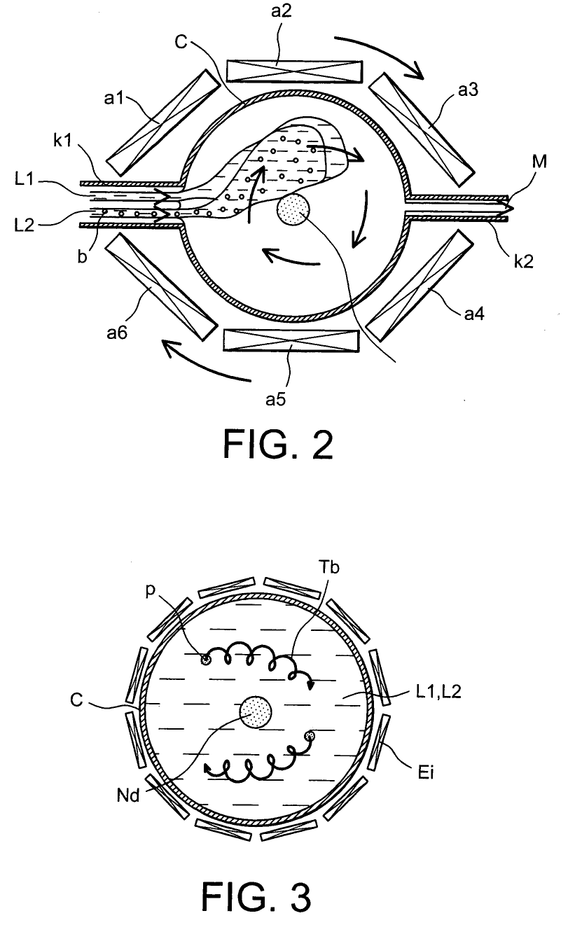

FIG. 2 represents an example of a mixing device according to the first embodiment of the invention.

The mixing device comprises electromagnets ai (i=1, 2, . . . , 6) regularly spaced out on the periphery of the chamber C and a central ferromagnetic core Nm. The liquids L1, L2 intended to be mixed are introduced into the chamber C via an input channel k1. An output channel k2 allows the mixture M of liquids to be extracted. The paramagnetic beads b are introduced into the chamber C, for example, with the liquid L2. In the case of a mixture of fluids with a carrier liquid (mixture of constituents in biochemistry), the carrier liquid may be introduced beforehand into said chamber C.

FIG. 3 represents a schematic diagram of a mixing device according to a second embodiment of the invention.

The second embodiment of the invention makes use of dielectrophoretic forces.

Dielectrophoresis is a known technique for producing an electric force on particles or large dielectric molecules in suspension in a buffer liquid, without however there being any appearance of an electric current. The electric field necessary to induce a dielectrophoretic force is produced by electrodes supplied by an alternating current of relatively high frequency (10 to 100 kHz). The applied force is then proportional to the root mean square of the effective electric field. Depending on the frequency of the field and the physical characteristics of the particles, one can obtain a positive force (directed towards the regions of high mean field) or negative force (directed towards the regions of low mean field).

The known principal applications are in the field of the separation of species or constituents, using positive or negative dielectrophoresis. For example, one can separate cells, bioparticles or bacteria with different dielectrophoretic properties (cf. the article “Microfluidic cell separation by 2-dimensional dielectrophoresis”, Biomedical Microdevices 2 :1, pp. 41-49, 1999 and the article “Introducing electrophoresis as a new force for field-flow fractionation”, Biophysical Journal, vol. 73, pp. 1118-1129, 1997).

The mixing device according to the second embodiment of the invention comprises a chamber C which contains the liquids to be mixed, a dielectric core Nd, preferentially centred in said chamber C and electrodes Ei (I=1, 2, . . . , n) supplied with an alternating current and regularly spaced out on the periphery of said chamber C.

Said chamber C may advantageously have very small dimensions (typical dimensions of 100 μm to 2 mm). The electrodes are linked by electrode pairs, the electrodes of a same pair being situated opposite each other on either side of the chamber C. Said electrode pairs are supplied alternately, in rotating around the dielectric core, according to a supply velocity, for example, of around 1 rd/s to 100 rd/s. The supply velocity of the electrode pairs is chosen as a function of the type of particles to be mixed. The permittivity ε_{c} of the dielectric core is greater that the permittivity of the fluids to be mixed. Preferentially, the electrodes are electrically isolated from the fluids in order to prevent local ionisation effects on contact with the electrodes. The frequency f_{elec} of the alternating current that supplies the electrodes is chosen as a function of the constituents to be mixed. It is generally between 1 kHz and 100 kHz.

The particles p of liquids to be mixed are displaced around the dielectric core according to a trajectory Tb which has more or less important radial fluctuations as a function of the frequency fᵣₒₜ of the supply of the electrode pairs and the frequency f_{elec} of the alternating current which supplies the electrodes. The frequency f_{elec} of the electric current that supplies the electrodes determines the positive or negative coefficient of the force that is applied to a particle. The frequency fᵣₒₜ of rotation of the supply of the electrodes determines the velocity and amplitude of the rotational movement and the radial movement of the particles.

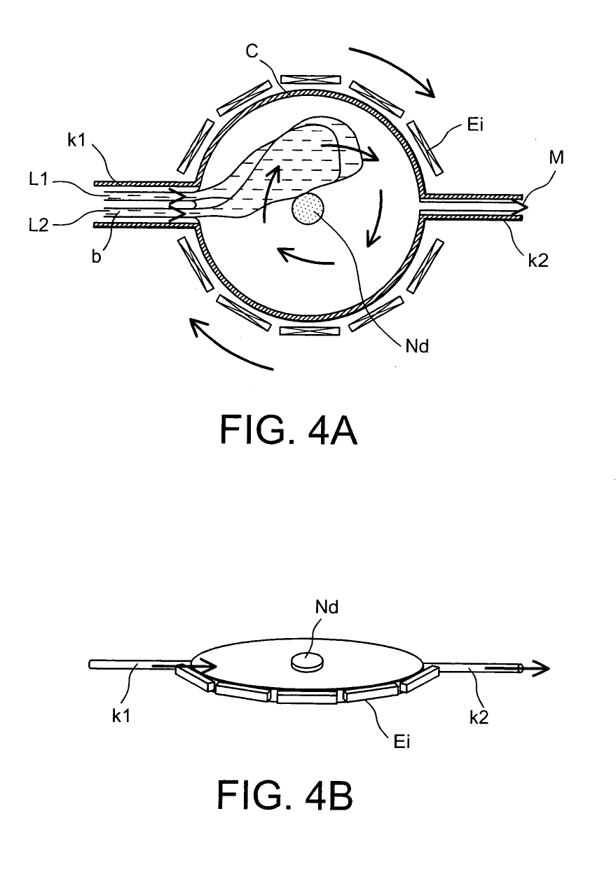

FIGS. 4A and 4B represent a plan view and a side view of an example of a mixing device according to the second embodiment of the invention.

The mixing device comprises electrodes Ei (i=1, 2, . . . , 10) regularly spaced out on the periphery of the chamber C and a central dielectric core Nd. The liquids L1, L2 intended to be mixed are introduced into the chamber C via an input channel k1. An output channel k2 allows the mixture M of liquids to be extracted. Here again, in the case of a mixture of fluids with a carrier liquid (mixture of constituents in biochemistry), the carrier liquid may be introduced beforehand into the chamber C.

The principle of the invention is based on a similitude between the dielectrophoretic force and the magnetic force. In the first case (dielectrophoresis), the force is proportional to the root mean square (RMS) of the electric field and, in the second case (magnetism), the force is proportional to the root mean square of the magnetic field. A complete similitude has been demonstrated by calculation between the distribution of a magnetic field and the distribution of a dielectrophoretic field in a similar geometry (uniform exterior magnetic field between 2 magnets (case of magnetism) or dielectrophoretic field between 2 electrodes (case of dielectrophoresis).

Different application examples of the invention may be given. In biology, one frequently wishes to accelerate the diffusion process in order to allow mobile targets to approach immobile probes. It is then possible, for example, to plate the capture surface on the central core of the device according to the invention, which then makes it possible to increase the capture rate. In chemistry, reactions often require obtaining thorough mixtures in which the proportions are well defined (stoichiometric proportions). The mixing device according to the invention meets this requirement particularly well.

1. Device for mixing fluids comprising a chamber (C) in which are present the fluids to be mixed (L1, L2), characterised in that it comprises means (ai, Ei) for displacing, around a central point, under the action of a force, the particles present in said chamber (C), the trajectory of said particles having radial fluctuations in relation to the central point.

2. Device according to claim 1, characterised in that the particles are paramagnetic beads (b) and in that the means for displacing said particles comprise means for establishing a magnetic field rotating around the central point.

3. Device according to claim 2, characterised in that the means for establishing a magnetic field rotating around the central point comprise permanent magnets (A1, A2) rotating around the central point and a ferromagnetic core (Nm) placed at the level of the central point.

4. Device according to claim 2, characterised in that the means for establishing a magnetic field rotating around the central point comprise electromagnets (ai) and a ferromagnetic core (Nm) placed at the level of the central point.

5. Device according to claim 1, characterised in that the particles are molecules (p) of at least one of the fluids to be mixed and in that the means for displacing the particles comprise means for establishing a dielectrophoretic field rotating around the central point.

6. Device according to claim 5, characterised in that the means for establishing a dielectrophoretic field rotating around the central point comprise a dielectric core (Nd) placed at the level of the central point, the dielectric constant (ε_{c}) of the dielectric core having a value greater that the dielectric constant of the fluids to be mixed, and electrode pairs (Ei) on the periphery of the chamber, the two electrodes of a pair being situated opposite each other, on either side of the chamber (C), said electrode pairs being supplied alternately, in rotating around the dielectric core, by an alternating current.

7. Device according to claim 6, characterised in that the electrodes (E1) are electrically isolated from the fluids to be mixed in order to avoid a local ionisation of said fluids.

8. Device according to claim 6 or 7, characterised in that the frequency of the alternating current supplying the electrodes (Ei) is between 1 kHz and 100 kHz.
